(19) United States
(12) Patent Application Publication
(10) Pub. No.: US 2015/0103213 A1
(43) Pub. Date: Apr. 16, 2015

(54) Method for Reducing Smear Effect in Image Capturing Device

(71) Applicant: Altek Corporation, Hsinchu (TW)

(72) Inventors: Che-Lun Chuang, Hsinchu City (TW); Chung-Ta Wu, Taichung City (TW); Hsin-Te Wang, Caotun Township (TW); Yi-Hsien Lin, Hsinchu City (TW)

(73) Assignee: Altek Corporation

(21) Appl. No.: 14/577,919

(22) Filed: Dec. 19, 2014

Related U.S. Application Data
(62) Division of application No. 13/414,273, filed on Mar. 7, 2012.

(30) Foreign Application Priority Data
Jan. 11, 2012 (TW) 101101156

(51) Int. Cl. H04N 5/359

(52) U.S. Cl. CPC H04N 5/3595
USPC 348/249

(57) ABSTRACT

A device and a method for reducing a smear effect. The device comprises an image sensing module and a smear reduction module. The image sensing module captures an image and optical black data generated from the optical area of the image sensing module. The smear reduction module searches the optical black data generated in the lower boundary of the optical black area corresponding to which generated in the upper boundary of the optical black area according to coordinates of the optical black data. Thereby, the smear reduction module can compute an offset line representing an offset of the optical black data, and the smear reduction module compensates the smear effect occurring in the image.

### CROSS-REFERENCE TO RELATED APPLICATION

This application is a divisional of U.S. patent application Ser. No. 13/414,273, filed on Mar. 7, 2012 in the United States Patent and Trademark Office, which claims the benefit of Taiwan Patent Application No. 101101156, filed on Jan. 11, 2012 in the Taiwan Intellectual Property Office, the disclosures of which are incorporated herein in their entirety by reference.

### BACKGROUND OF THE INVENTION

1. Field of the Invention

The present invention relates to an image capturing device and an image processing technology, and more particularly to the image capturing device capable of reducing a smear effect and the method for reducing the smear effect.

2. Description of Related Art

Smear effect is a side effect frequently occurred when a charge coupled device (CCD) captures images. The smear effect gives rise to a photoflood phenomenon of an image sensor of the charge coupled device due to accumulated electric charges, such that a very bright vertical line usually occurs at bright spots of the images. If a strong light is projected into the charge coupled device, the light passes through a vertical transmission part of the charge coupled device to induce the bright vertical line caused by the extra electric charges.

When the light source and the image capturing device remain still, the smear effect occurred in the image produces a very bright vertical line. When the light source or the image capturing device is moved sideways, a skew smear effect occurred in the image produces a skew light. Since the light source or the image capturing device is usually moving when the image capturing device such as a digital camera or a digital camcorder is operated, therefore the smear effect usually produces a skew light.

However, the image processing technology adopted by the conventional image capturing devices cannot reduce or eliminate the smear effect occurred when the image capturing device or the light source is moving. Therefore, it is a subject for related manufacturers to develop an image capturing device capable of reducing the smear effect when the image capturing device or the light source is moving.

### SUMMARY OF THE INVENTION

In view of the aforementioned problems of the prior art, it is a primary objective of the invention to provide an image capturing device and a method for reducing a smear effect to overcome the shortcomings of the prior art.

To achieve the foregoing objective, the present invention provides an image capturing device capable of reducing a smear effect. The image capturing device comprises: an image sensing module for capturing an image and optical black data (OB data) generated from an optical black area (OB area) of the image sensing module and a smear reduction module for compensating a smear effect in the image according to the optical black data. Wherein, the smear reduction module searches the optical black data generated in the lower boundary of the optical black area corresponding to the optical data generated in the upper boundary of the optical black area according to coordinates the optical black data. Thereby, the smear effect module can compute an offset line representing an offset of the optical black data, and compensate the smear effect in the image according to the offset line and the optical black data.

To achieve the foregoing objective, the present invention further provides a method for reducing a smear effect, and the method comprises the steps of: using an image sensing module to capture an image and optical black data generated from an optical black area of the image sensing module; and using a smear reduction module to search the optical black data generated in the lower boundary of the optical black area corresponding to the optical data generated in the upper boundary of the optical black area according to coordinates of the optical black data to compute an offset line capable of representing an offset of the optical black data, and compensate the smear effect in the image according to the offset line and the optical black data.

Wherein, a motion estimation module is further provided for executing a motion estimation (ME) to generate a motion vector (MV) for calculation of a first horizontal shift of the image.

Wherein, a trend line generating module is further provided, such that when only one of the upper boundary and the lower boundary of the optical black area can generate the optical black data, the trend line generating module executes a curve fitting according to the optical black data and the first horizontal shift to produce a trend line capable of representing an offset of the optical black data. The smear reduction module compensates the smear effect in the image according to the trend line and the optical black data.

Wherein, a gravity sensing module is further provided for produce a second horizontal shift when it is detected that the image capturing device moves.

Wherein, the trend line generating module is provided, such that when only one of the upper boundary and the lower boundary of the optical black area can generate the optical black data, the trend line generating module executes a curve fitting according to the optical black data and the second horizontal shift to produce a trend line capable of representing an offset of the optical black data. The smear reduction module compensates the smear effect in the image according to the trend line and the optical black data.

To achieve the foregoing objective, the present invention further provides an image capturing device capable of reducing a smear effect, and the image capturing device comprises: an image sensing means, for capturing an image and optical black data generated from an optical black area of the image sensing module; and a smear reduction means, for compensating the smear effect in the image according to the optical black data. Wherein, the smear reduction means searches the optical black data generated in the lower boundary of the optical black area corresponding to the optical data generated in the upper boundary of the optical black area according to coordinates of the optical black data. Thereby, the smear reduction module can compute an offset line representing an offset of the optical black data, and compensate the smear effect in the image according to the offset line and the optical black data.

Wherein, the image capturing device further comprises a motion estimation means, for executing a motion estimation to generate a motion vector for calculation of a first horizontal shift of the image.

Wherein, the image capturing device further comprises a trend line generating means, and when only one of the upper boundary and the lower boundary of the optical black area can generate the optical black data, the trend line generating means execute a curve fitting according to the optical black data and the first horizontal shift to produce a trend line. Thereby, the smear reduction module compensates the smear effect in the image according to the trend line and the optical black data.

Wherein, the image capturing device further comprises a gravity sensing means, for producing a second horizontal shift when it is detected that the image capturing moves.

Wherein, the image capturing device further comprises a trend line generating means, and when only one of the upper boundary and the lower boundary of the optical black area can generate the optical black data, the trend line generating means execute a curve fitting according to the optical black data and the second horizontal shift to produce a trend line. Thereby, the smear reduction module compensates the smear effect in the image according to the optical black data and the trend line.

In summation, the image capturing device capable of reducing a smear effect in accordance with the present invention has one or more of the following advantages:

(1) The present invention connects the optical black data of the upper and lower boundaries of the optical black area and uses the curve fitting method to overcome the skew smear effect caused by the moving light source or image capturing device.

(2) The present invention uses the curve fitting method to estimate the optical black data which are beyond the image, so as to effectively overcome the problem of having no optical black data at the edges of the image, and achieve a correct compensation for the image.

### BRIEF DESCRIPTION OF THE DRAWINGS

FIG. 1 is a block diagram of an image capturing device capable of reducing a smear effect in accordance with a first preferred embodiment of the present invention;

FIG. 2 is a flow chart of an image capturing device capable of reducing a smear effect in accordance with the first preferred embodiment of the present invention;

FIG. 3 is a block diagram of an image capturing device capable of reducing a smear effect in accordance with a second preferred embodiment of the present invention;

FIG. 4 is a flow chart of an image capturing device capable of reducing a smear effect in accordance with the second preferred embodiment of the present invention;

FIG. 5 is a block diagram of an image capturing device capable of reducing a smear effect in accordance with a third preferred embodiment of the present invention;

FIG. 6 is a flow chart of an image capturing device capable of reducing a smear effect in accordance with the third preferred embodiment of the present invention;

FIG. 7 is a schematic view of compensating a smear effect by a conventional image capturing device;

FIG. 8 is a schematic view of compensating a smear effect by an image capturing device of the present invention;

FIG. 9 is a schematic view of a practical application of using an image capturing device to compensate a smear effect in accordance with the present invention; and

FIG. 10 is a flow chart of a method for reducing a smear effect in accordance with the present invention.

### DETAILED DESCRIPTION OF THE PREFERRED EMBODIMENTS

The technical contents and characteristics of the image capturing device and its image processing method in accordance with the present invention will be apparent with the detailed description of a preferred embodiment accompanied with related drawings as follows. For simplicity, same numerals are used in the following preferred embodiment to represent respective same elements.

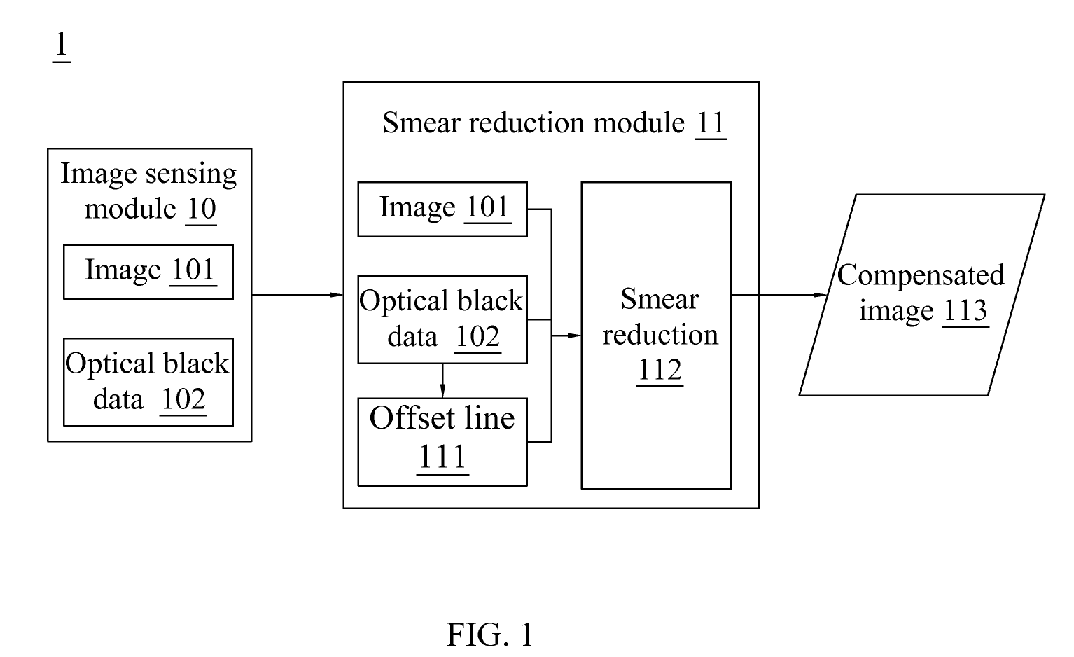

With reference to FIG. 1 for a block diagram of an image capturing device capable of reducing a smear effect in accordance with a first preferred embodiment of the present invention, the image capturing device 1 comprises an image sensing module 10 and a smear reduction module 11. The image sensing module 10 is provided for capturing an image 101 and optical black data (OB data) 102 are generated by an optical black area (OB area) of the image sensing module 10. The image sensing module 10 can be a charge coupled device (CCD).

The smear reduction module 11 searches the optical black data 102 generated in a lower boundary of the optical black area corresponding to the optical data 102 generated in a upper boundary of the optical black area according to coordinates of the optical black data 102. The smear reduction module 11 connects the optical black data 102 generated from the upper boundary of the optical black area with the optical black data 102 generated from the lower boundary of the optical black area to estimate an offset of the optical black data 102 to produce an offset line 111. Therefore, the smear reduction module 11 can compute an offset line capable of representing an offset of the optical black data according to the offset, and execute a smear reduction 112 to generate a compensated image 113 according to the offset line 111 and the optical black data 102.

It is noteworthy to point out that the conventional image capturing device analyzes the optical black data generated from the optical black area of the image sensor, and the value of the optical black data is subtracted from each pixel in the image with the smear effect along a vertical direction or the value of the optical black data corresponding to a lookup table is subtracted to eliminate the smear effect. This method effectively reduces the smear effect of a still light source and a still image capturing device. However, if the light source and image capturing device are moving, the smear effect is a skew light. Thus, the present existing image processing technology cannot eliminate the skew smear effect, or even subtracts a too-large value of the optical black data from some areas of the image without any smear effect, or the image capturing device makes a wrong compensation for the image.

The smear reduction module 11 of the present invention connects the optical black data 102 generated by the upper boundary of the optical black area with the optical black data 102 generated by the lower boundary of the optical black area to compute an offset line 111, and the offset line 111 is used to estimate an area of the image having the smear effect in order to execute a correct compensation. Therefore, the present invention can effectively reduce the skew smear effect caused by the moving light source and image capturing device.

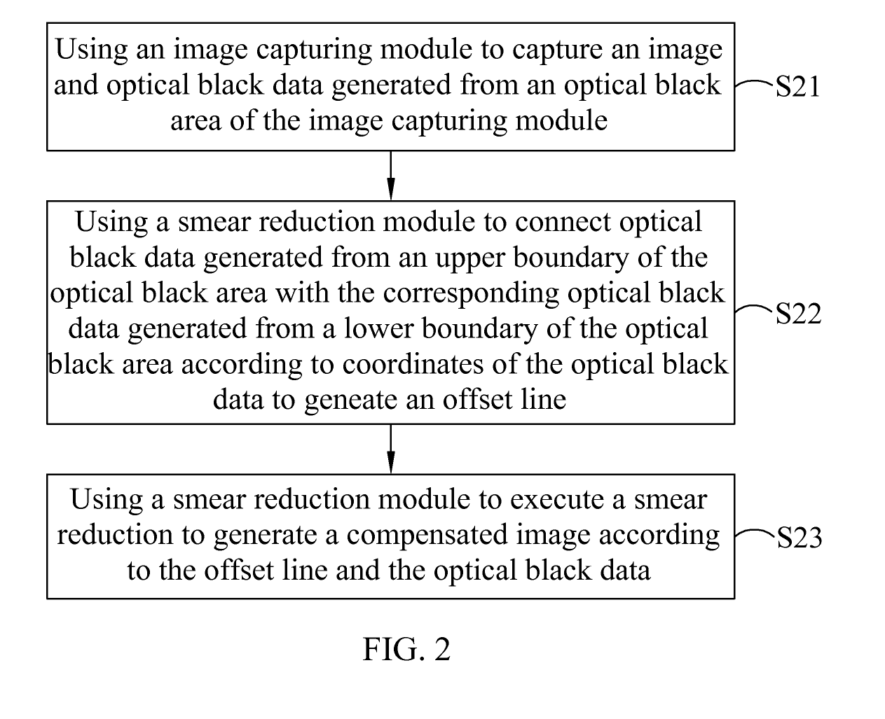

With reference to FIG. 2 for a flow chart of an image capturing device capable of reducing a smear effect in accordance with the first preferred embodiment of the present invention, the image capturing device is operated in a procedure comprising the following steps:

S21: Using an image sensing module to capture an image and optical black data generated from an optical black area of the image sensing module.

S22: Using a smear reduction module to connect optical black data generated from an upper boundary of the optical black area with the corresponding optical black data generated from a lower boundary of the optical black area according to coordinates of the optical black data to generate an offset line.

S23: Using a smear reduction module to execute a smear reduction to generate a compensated image according to the offset line and the optical black data.

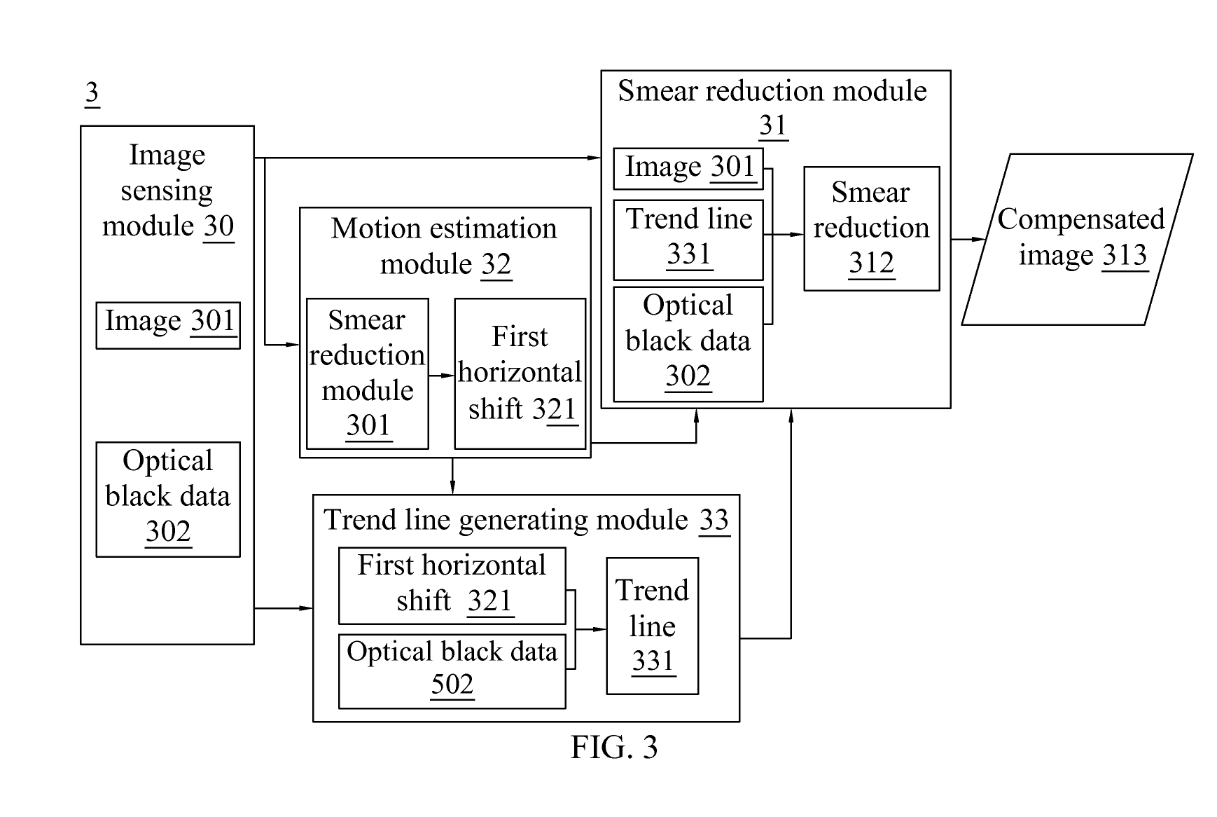

With reference to FIG. 3 for a block diagram of an image capturing device capable of reducing a smear effect in accordance with the second preferred embodiment of the present invention, the image capturing device 3 comprises an image sensing module 30, a smear reduction module 31, a motion estimation module 32 and a trend line generating module 33. The image sensing module 30 captures an image 301 and optical black data 302 generated from an optical black area of the image sensing module 30.

If only one of the upper boundary and the lower boundary boundaries of the optical black area can generate the optical black data 302, the method of the first preferred embodiment cannot be used for executing the smear reduction 312. Therefore, this preferred embodiment uses a motion estimation module 32 to execute a motion estimation (ME) to generate a motion vector (MV) and analyze two consecutive images to calculate a first horizontal shift 321 of the image 301.

The trend line generating module 33 can use the first horizontal shift 321 to determine a moving direction of the image capturing device 3 or the image 301. For example, if the image capturing device 3 moves to the right side, the smear effect provides a skew light passing from the upper right to the lower left. On the other hand, if the image capturing device 3 moves to the left side, the smear effect is a skew light passing from the upper left to the lower right. Therefore, the trend line generating module 33 can execute a curve fitting to generate a trend line 331 according to the first horizontal shift 321 and the optical black data 302.

The smear reduction module 31 can estimate an area of the image 301 that generates the optical black data 302 by the trend line 331, the image 301 and the optical black data 302 to execute a smear reduction 312 to generate a compensated image 313.

It is noteworthy to point out that different CCD image sensors have different detection capabilities. A high-end CCD image sensor generally can detect optical black data generated from the upper and lower boundaries of the optical black area, and a low-end CCD image sensor generally can detect one of the optical black data generated from the upper and lower boundaries of the optical black area. If the optical black area has only one boundary capable of generating the optical black data, then the method of the first preferred embodiment cannot be used for execute the compensation of the smear effect. Therefore, the image capturing device of the present invention provides a motion estimation function for computing a trend line to execute the compensation of the smear effect. The curve fitting method of the present invention can be used for estimating the optical black data beyond the image to overcome of the problem that there is no optical black data at the edges of the image.

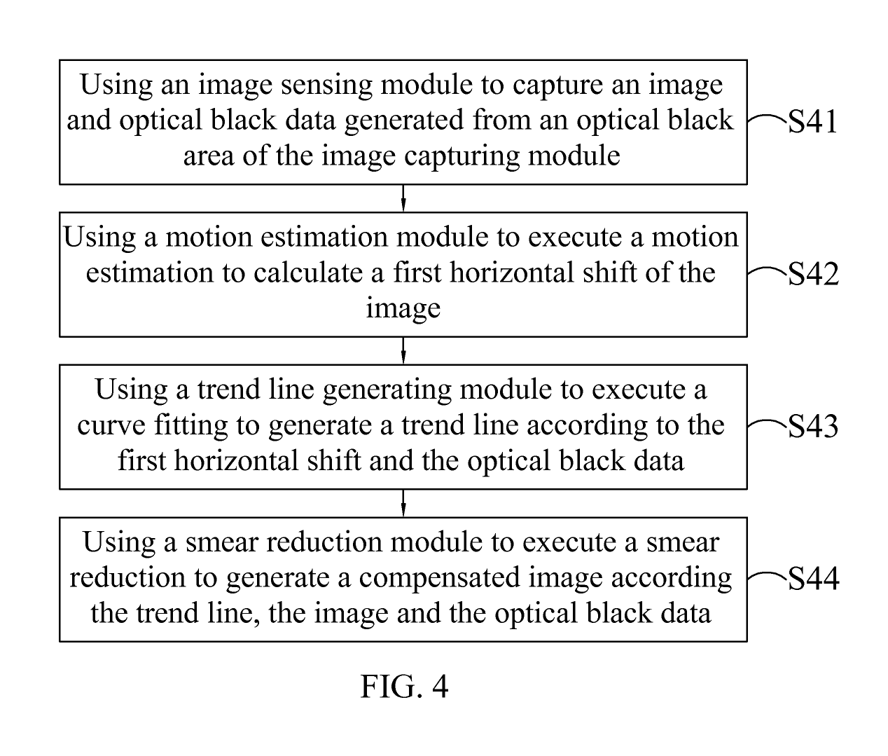

With reference to FIG. 4 for a flow chart of an image capturing device capable of reducing a smear effect in accordance with the second preferred embodiment of the present invention, the method comprises the following steps:

S41: Using an image sensing module to capture an image and optical black data generated from an optical black area of the image sensing module.

S42: Using a motion estimation module to execute a motion estimation to calculate a first horizontal shift of the image.

S43: Using a trend line generating module to execute a curve fitting to generate a trend line according to the first horizontal shift and the optical black data.

S44: Using a smear reduction module to execute a smear reduction to generate a compensated image according the trend line, the image and the optical black data.

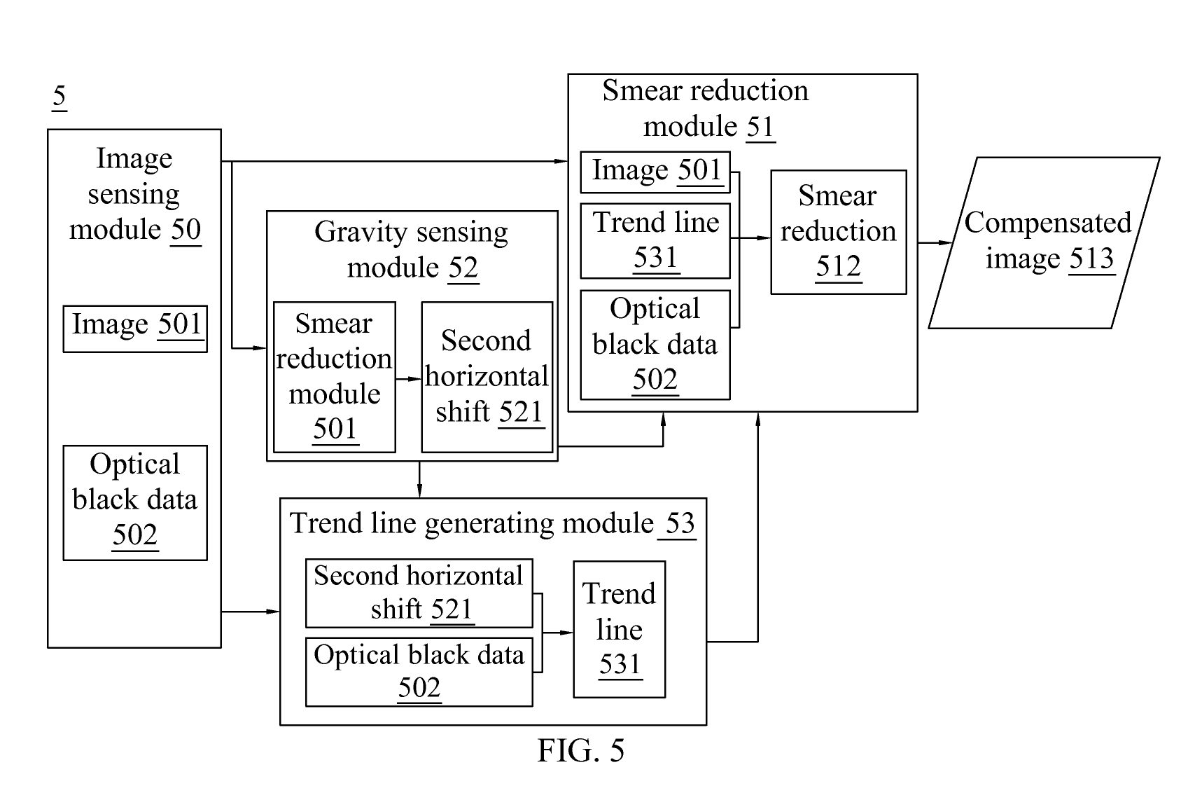

With reference to FIG. 5 for a block diagram of an image capturing device capable of reducing a smear effect in accordance with the fifth preferred embodiment of the present invention, the image capturing device 5 comprises an image sensing module 50, a smear reduction module 51, a gravity sensing module 52 and a trend line generating module 53. The image sensing module 50 captures an image 501 and optical black data 502 generated from an optical black area of the image sensing module 50.

In this preferred embodiment, if the image capturing device 5 moves, and only one of the upper boundary and the lower boundary of the optical black area can generate optical black data 502, a gravity sensing module 52 is used to compute a second horizontal shift 521 of the image capturing device 5. The gravity sensing module 52 can be a gyro-sensor.

Similarly, the trend line generating module 53 can use the second horizontal shift 521 to determine a moving direction of the image capturing device 5. The trend line generating module 53 can execute a curve fitting to generate a trend line 531 according to the second horizontal shift 521 and the optical black data 502.

The smear reduction module 51 can estimate an area in the image 501 generating the optical black data 502 by the trend line 531, the image 501 and the optical black data 502 in order to execute a smear reduction 512 to generate a compensated image 513.

Of course, the present invention can switch the use of the motion estimation module and the gravity sensing module if needed, when the image or the image capturing device moves, so as to compute a trend line of the optical black data, and the trend line can be used for compensating the smear effect in the image.

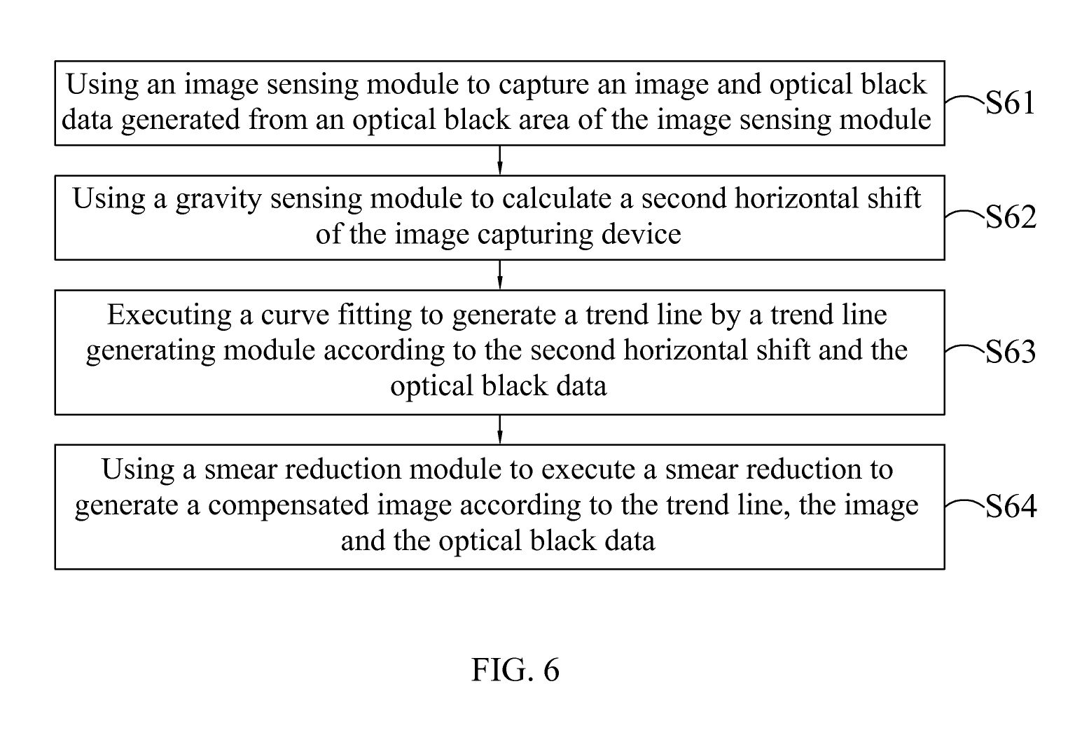

With reference to FIG. 6 for a flow chart of an image capturing device capable of reducing a smear effect in accordance with the third preferred embodiment of the present invention, the image capturing device is operated in a procedure comprising the following steps:

S61: Using an image sensing module to capture an image and optical black data generated from an optical black area of the image sensing module.

S62: Using a gravity sensing module to calculate a second horizontal shift of the image capturing device.

S63: Executing a curve fitting to generate a trend line by a trend line generating module according to the second horizontal shift and the optical black data.

S64: Using a smear reduction module to execute a smear reduction to generate a compensated image according to the trend line, the image and the optical black data.

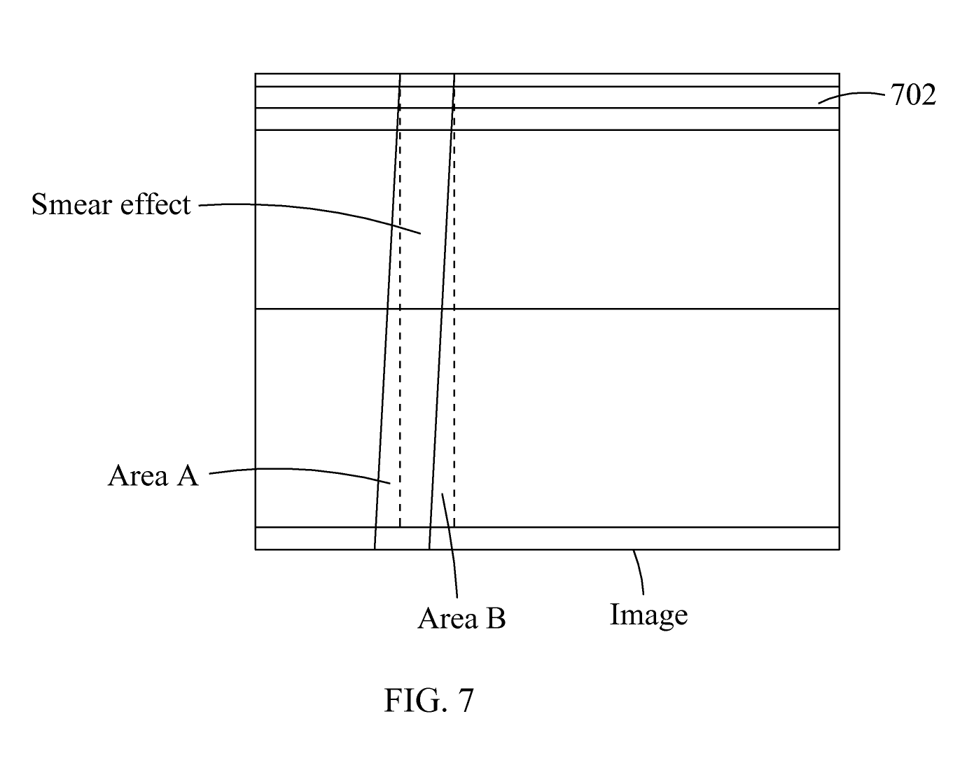

With reference to FIG. 7 for a schematic view of compensating a smear effect by a conventional image capturing device, if the image capturing device moves to the right side, the smear effect in the image is a skew light passing from the upper right to the lower left. The conventional image processing technology subtracts the value of optical black data in each pixel in the image with a smear effect along a vertical direction according to the optical black data 702, or subtracts the value of the optical black data corresponding to a lookup table to reduce the smear effect. However, such arrangement may subtract a too-small value of the optical black data from an area A, and a too-large value of the optical black data from an area B. As a result, the image capturing device may compensate the image incorrectly.

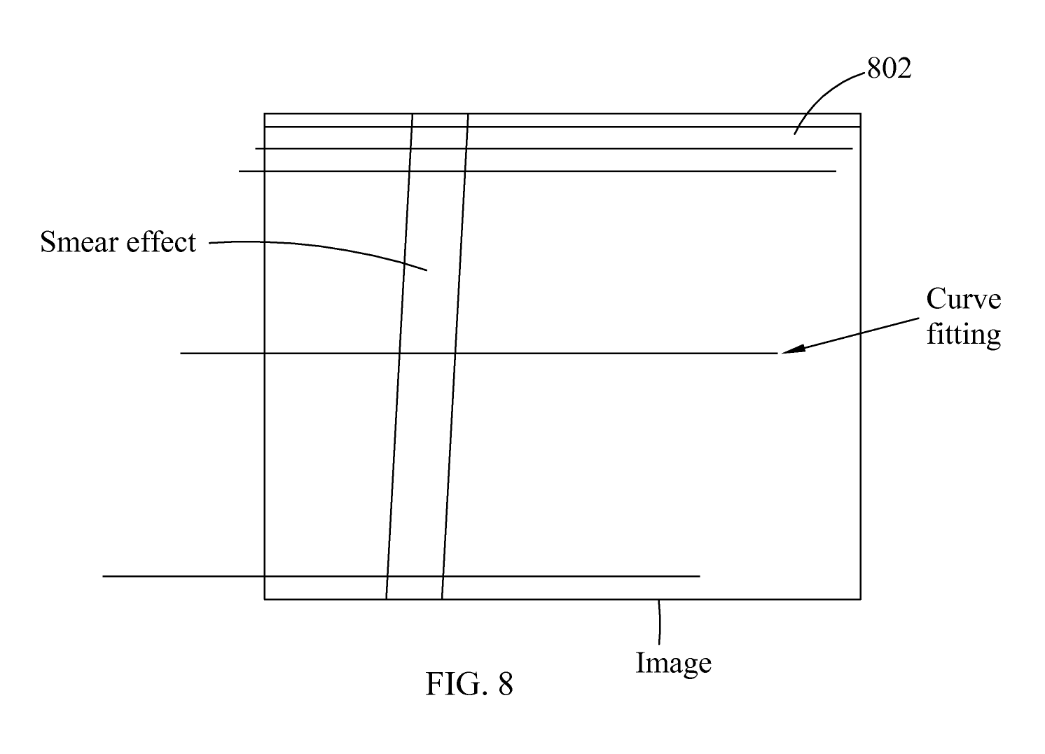

With reference to FIG. 8 for a schematic view of compensating a smear effect by an image capturing device of the present invention, if the skew smear effect occurs, the image processing technology of the present invention will base on the optical black data 802 and use a motion estimation module or a gravity sensing module to compute a horizontal shift of the light source or the image capturing device. The trend line generating module uses the horizontal shift and the optical black data 802 to execute a curve fitting to generate a trend line. The smear reduction module uses the trend line and the optical black data 802 to compensate an area in the image having the smear effect. The method of the present invention can be used to estimate the optical black data beyond the image to overcome the problem of having no optical black data at the edges of the image, so as to effectively reduce the smear effect of the light source occurred at the edges of the image.

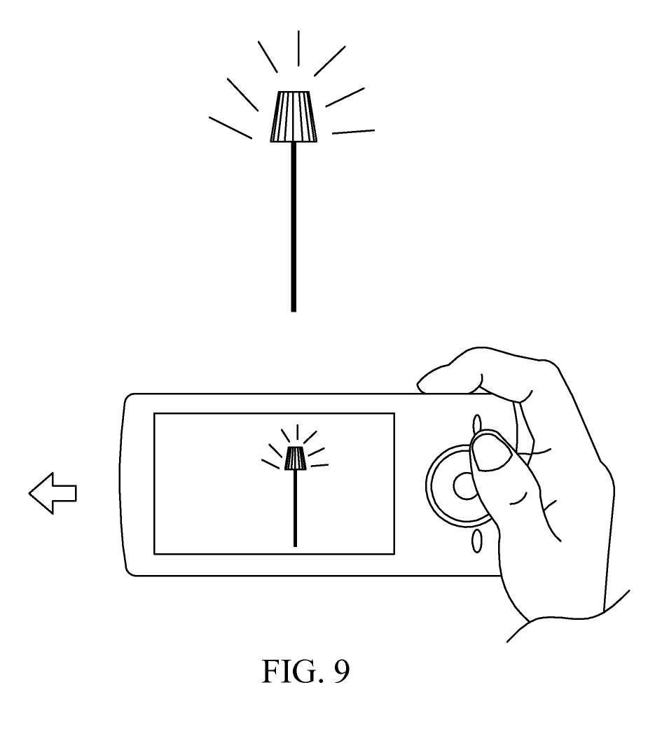

With reference to FIG. 9 for a schematic view of a practical application of using an image capturing device to compensate a smear effect in accordance with the present invention, if the user of the image capturing device moves to the left, the gravity sensing module calculates a horizontal shift of the image capturing device. The trend line generating module uses the horizontal shift and the optical black data to execute a curve fitting to estimate the position of the optical black data in the image, so that the smear reduction module can compensate the image correctly.

Even though the concept of the method for reducing a smear effect in accordance with the present invention has been described in the section of the image capturing device capable of reducing a smear effect of the invention, a flow chart is provided for illustrating the method clearly as follows.

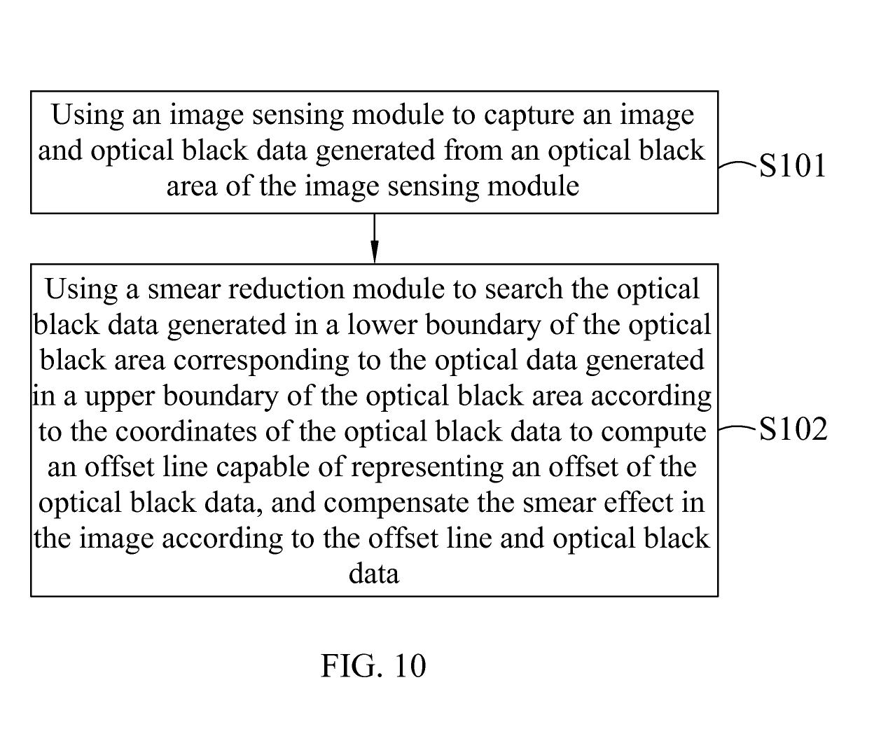

With reference to FIG. 10 for a flow chart of a method for reducing a smear effect in accordance with the present invention, the method comprises the following steps:

S101: Using an image sensing module to capture an image and optical black data generated from an optical black area of the image sensing module.

S102: Using a smear reduction module to search the optical black data generated in a lower boundary of the optical black area corresponding to the optical data generated in a upper boundary of the optical black area according to the coordinates of the optical black data to compute an offset line capable of representing an offset of the optical black data, and compensate the smear effect in the image according to the offset line and optical black data.

The concept and implementation of the method for reducing a smear effect in accordance with the present invention have been described in the section of the image capturing device capable of reducing a smear effect of the present invention, and thus they will not be repeated.

The image capturing device capable of reducing a smear effect and the method for reducing the smear effect present invention can connect optical black data of the upper and lower boundaries of the optical black area and use the curve fitting method to effectively overcome the skew smear effect caused by the moving light source or image capturing device. The present invention uses the curve fitting method to effectively estimate the optical black data beyond the image, so that the invention can effectively overcome the problem of having no optical black data at the edges of the image, so that the image can be compensated correctly.

In summation of the above description, the present invention herein enhances the performance than the conventional structure and further complies with the patent application requirements and is submitted to the Patent and Trademark Office for review and granting of the commensurate patent rights.

What is claimed is:

1. A method for reducing a smear effect, comprising steps of:
using an image sensing module to capture an image and optical black data generated from an optical black area of the image sensing module;
using a smear reduction module to search the optical black data generated in a lower boundary of the optical black area corresponding to the optical data generated in a upper boundary of the optical black area according to coordinates of the optical black data to compute an offset line capable of representing an offset of the optical black data, and compensate the smear effect in the image according to the offset line and the optical black data;
using a motion estimation module to execute a motion estimation to generate a motion vector for calculation of a first horizontal shift of the image;
executing a curve fitting to generate a trend line capable of representing an offset of the optical black data according to the optical black data and the first horizontal shift by a trend line generating module, when only one of the upper boundary and the lower boundary of the optical black area can generate the optical black data; and
compensating the smear effect in the image according to the trend line and the optical black data by the smear reduction module.
